(19) United States
(12) Patent Application Publication
(10) Pub. No.: US 2015/0137509 A1
(43) Pub. Date: May 21, 2015

(54) CLAMP APPARATUS HAVING INDEXING FEATURE

(71) Applicant: MANN+HUMMEL GMBH, Ludwigsburg (DE)

(72) Inventors: Michael Desjardins, Willow Spring, NC (US); Charles Rupert, Dardenne Prairie, MO (US)

(73) Assignee: MANN+HUMMEL GMBH, Ludwigsburg (DE)

(21) Appl. No.: 14/086,428

(22) Filed: Nov. 21, 2013

(51) Int. Cl. F16L 21/00

(52) U.S. Cl. CPC F16L 21/005
USPC 285/236; 29/428

(57) ABSTRACT

A clamp apparatus is disclosed which has a duct having an indexing feature formed thereon. A wire clamp is provided which has a length of resilient spring material shaped generally in accordance with a cross sectional configuration and diameter of the duct. A tightening component is operatively coupled to the length of resilient spring material. A portion of the wire clamp engages with the indexing feature to enable the wire clamp to be positioned and held in a desired angular orientation on the duct while being tightened on the duct using the tightening component.

### FIELD

The present disclosure relates to duct and hose clamps, and more particularly to a wire-style clamp well suited for use with ducts and hoses that incorporates an indexing feature for quickly and easily aligning the clamp on the duct or hose in a predetermined angular orientation on the duct or hose.

### BACKGROUND

The statements in this section merely provide background information related to the present disclosure and may not constitute prior art.

Clamps are often used to secure a plastic or rubber duct to another component. Typically such clamps have been of the band style and involve a band of metallic material of a predetermined width and thickness that is configured to rest within a groove or channel of the duct at one thereof. Typically the band style clamp includes a threaded screw that makes contact with a cutouts or slots in the band of material, somewhat like a ring and pinion arrangement. Advancing the threaded screw allows the band of material to be tightened over an edge of the duct. A simplified view of one such style of clamp is shown in FIG. 1.

In many applications where exposure to the elements and moisture is to be expected, the band of material of the clamp must be made of a suitable material which is resistant to moisture and other elements so that the clamp does not rust or corrode. Typically stainless steel is employed. However, as will be appreciated, manufacturing a band-style clamp from stainless steel can add significant cost to the construction of the clamp. This is in part because the band style clamp requires a fair amount of material metallic material for its construction.

It would be highly desirable to provide a clamp suitable for use with ducts and hoses that can be made significantly more economically than traditional band style hose clamps, and which also can be indexed to a predetermined position on a duct or hose when it is used to secure an end of the duct or hose to another component.

### SUMMARY

In one aspect the present disclosure relates to a clamp apparatus. The clamp apparatus may comprise a duct having an indexing feature formed thereon. A wire clamp may be included which has a length of resilient material shaped generally in accordance with a cross sectional configuration and diameter of the duct. A tightening component may be included which is operatively coupled to the length of resilient material. A portion of the wire clamp may engage with the indexing feature to enable the wire clamp to be positioned and held in a desired angular orientation on the duct while being tightened on the duct using the tightening component.

In another aspect the present disclosure may include a clamp apparatus that comprises a duct and a wire clamp. The duct may have a pair of ribs at least at one end thereof that form a channel. The channel may include an indexing feature formed in part by using the channel. The wire clamp may be comprised of a single length of resilient material shaped generally in accordance with a cross sectional configuration and diameter of the duct. The wire clamp may further comprise a threaded bolt operatively coupled to the length of resilient material. The wire clamp may further be configured to reside at least substantially within the channel and to be maintained in the channel by the pair of ribs of the channel. A portion of the wire clamp may engage with the indexing feature to enable the wire clamp to be positioned and held in a desired angular orientation on the duct while the threaded bolt is tightened.

In still another aspect the present disclosure relates to a method for forming a clamp apparatus. The method may comprise providing a duct having a channel at least at one end, and forming the channel using a pair of ribs. The method may also include forming an indexing feature using the channel of the duct. The method may also include providing a wire clamp having a length of resilient material shaped generally in accordance with a cross sectional configuration and diameter of the duct, and a threaded bolt operatively coupled to the length of resilient material. A portion of the wire clamp may be used to engage with the indexing feature to enable the wire clamp to be positioned and held in a desired angular orientation on the duct while the threaded bolt is being tightened.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of a portion of a prior art duct employing a traditional band style clamp and illustrating how the band style clamp is indexed to a certain angular position on the duct.

FIG. 2 is a perspective view of a duct clamp apparatus in accordance with one example embodiment of the present disclosure.

FIG. 3 is an enlarged perspective view of just the wire clamp shown in FIG. 2.

FIG. 4 is an enlarged perspective view of just a portion of the clamp apparatus in accordance with circled area 4 in FIG. 2, which illustrates in greater detail an indexing feature incorporated on the duct, as well as how the clamp engages the indexing feature to angularly align the clamp at a desired angular position on the duct when the clamp is tightened.

FIG. 5 is a perspective end view of the wire clamp and duct of FIG. 4 taken in accordance with directional line 5 in FIG. 4.

FIG. 6 a perspective view of another embodiment of the present disclosure which makes use of a different indexing feature associated with the duct.

FIG. 7 is a perspective view of just the wire clamp component shown in FIG. 6.

FIG. 8 is an enlarged perspective view of circled area 8 in FIG. 6 showing the indexing feature on the duct in greater detail.

FIG. 9 is an enlarged perspective view of the clamp apparatus of FIG. 8 taken in accordance with directional arrow 9 in FIG. 8.

FIG. 10 is a perspective view of another embodiment of a duct incorporating an indexing feature in accordance with the present disclosure at one end thereof.

FIG. 11 is a perspective view of just the clamp shown in FIG. 10.

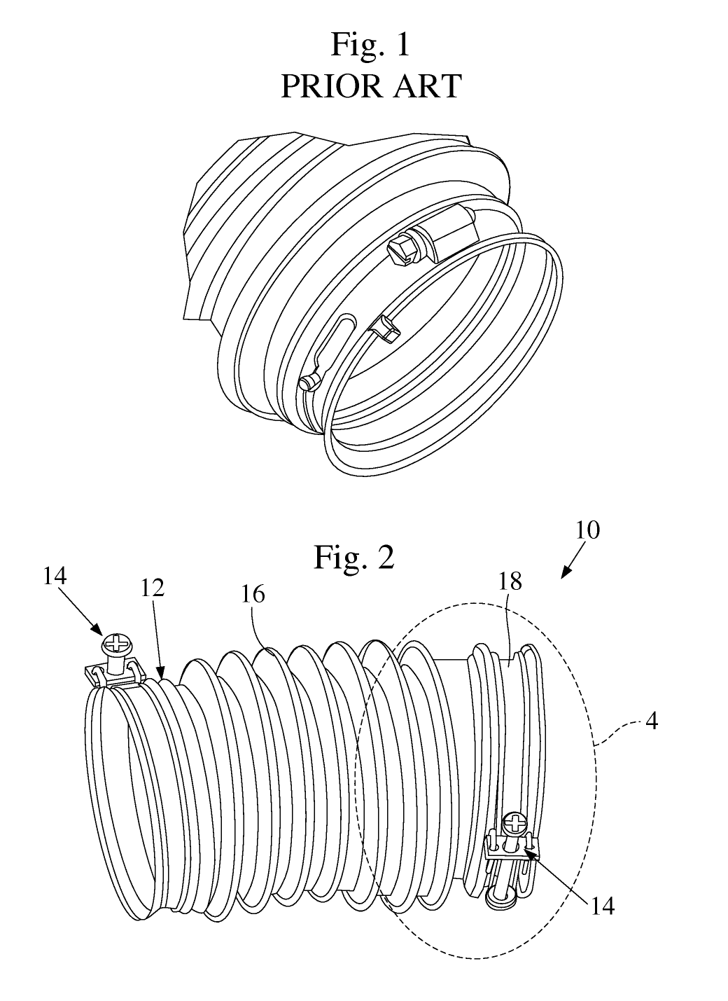

### DETAILED DESCRIPTION

The following description is merely exemplary in nature and is not intended to limit the present disclosure, application, or uses. It should be understood that throughout the drawings, corresponding reference numerals indicate like or corresponding parts and features.

Referring to FIG. 2 there is shown a duct clamp apparatus 10 in accordance with one embodiment of the present disclosure. The apparatus 10 may include a length of duct 12 and a wire clamp 14 at one end, or both ends, of the duct 12. The duct 12 may be made from any suitable material, but typically is made from a high strength plastic or rubber material, and typically has a plurality of integrally formed ribs 16 that providing structural reinforcement for the duct 12 while still allowing a degree of flexibility of the duct 12. A channel 18 may be formed at least at one end of the duct 12, or alternatively at both ends thereof. Each channel 18 provides an area within which the wire clamp 14 can be positioned.

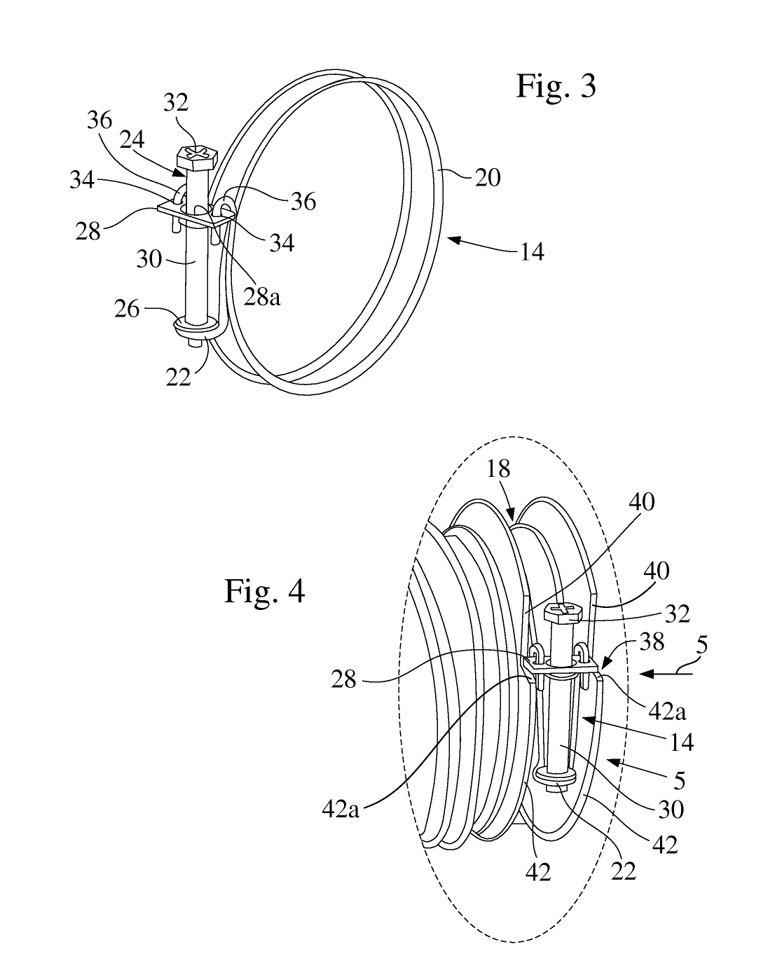

In FIG. 3 the clamp 14 can be seen in this example as being formed from a single length of resilient spring material 20, for example spring steel (e.g., stainless steel) (Inventors to comment on preferred materials for the clamp). The clamp 14 in this example has a circumferential shape to generally match the cross sectional shape of the duct 12, and a diameter which is generally similar to that of the duct. The clamp 14 may take other shapes, for example oblong, but the shape of the clamp should be reasonably close to the cross-sectional configuration and dimensions of the duct with which it is intended to be used.

With further reference to FIG. 3, the clamp 14 may include a base portion 22 which forms a somewhat U-shaped flange. The base portion 22 abuts a flange 26 of a fastener assembly 24. The fastener assembly 24 has a plate 28 with a threaded hole 28a that receives a threaded shaft 30 of a bolt 32. The flange 26 may be pressed on or otherwise secured to an unthreaded end portion of the threaded shaft 30 such that the flange 26 is fixed to the threaded shaft 30 and must rotate with the threaded shaft 30. The plate 28 also has a pair of openings 34 that receive terminal curved end portions 36 of the resilient spring material 20. Advancing the bolt 32 serves to push the flange 26 against the base portion 22 of the resilient spring material 20, which increases the spacing between the base portion 22 and the curved end portions 36, which tightens the clamp 14 on the duct 12. Rotating the bolt 32 in the opposite direction allows the spacing to be reduced, thus enlarging the diameter of the resilient spring material 20.

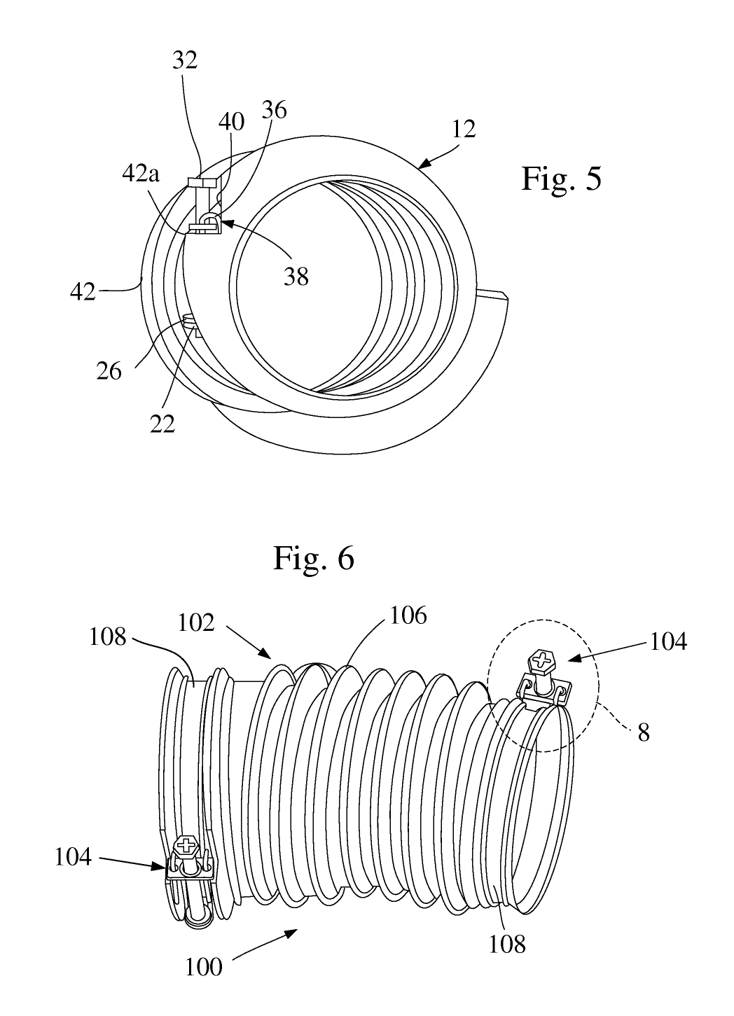

Referring to FIGS. 4 and 5, the duct 12 can be seen to include an indexing feature 38 associated with the channel 18. The indexing feature 38 in this example is formed by notched sections 40 of a pair of ribs 42 that help to form the channel 18. The notched sections 40 provide a pair of generally radially extending edge surfaces 42a which contact plate 28. This contact maintains the clamp 14 in a predetermined angular orientation on the duct 14 as the clamp is tightened. Thus, when installing the duct 12, typically the installer may position the ends of the duct 12 over the pair of components (not shown) which the duct is being used to complete a flow path. The installer may orientate the duct 12 so that the bolt 32 is in a comfortable angular position by which it can be tightened. The indexing feature 38 prevents the clamp 14 from rotating on the duct 12 as force is being applied to the bolt 32 while it is being tightened.

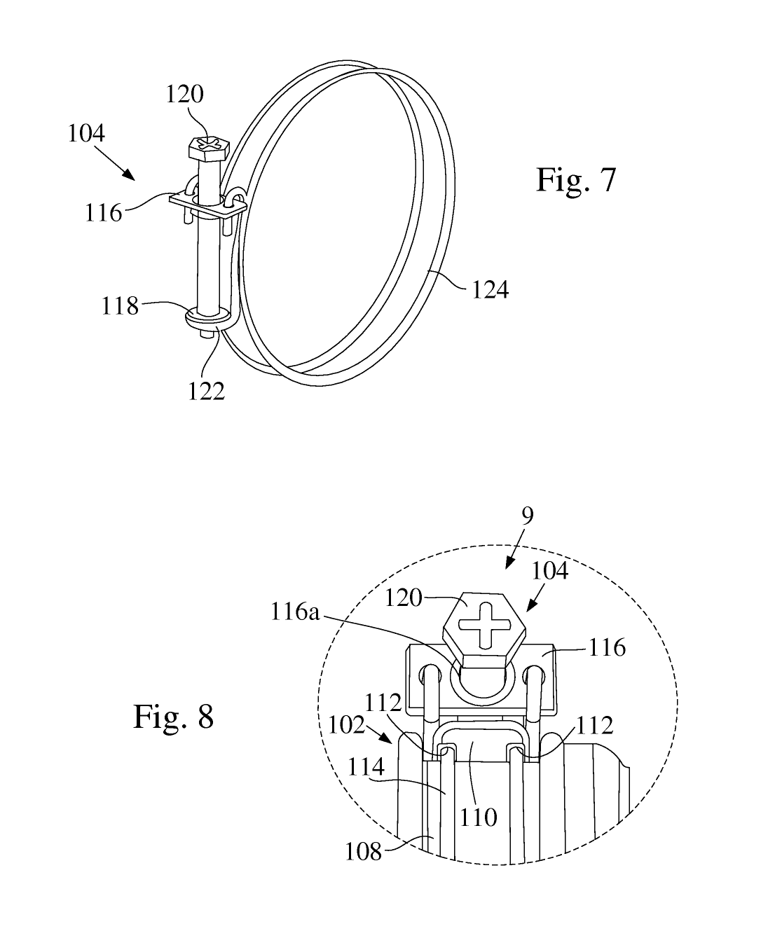

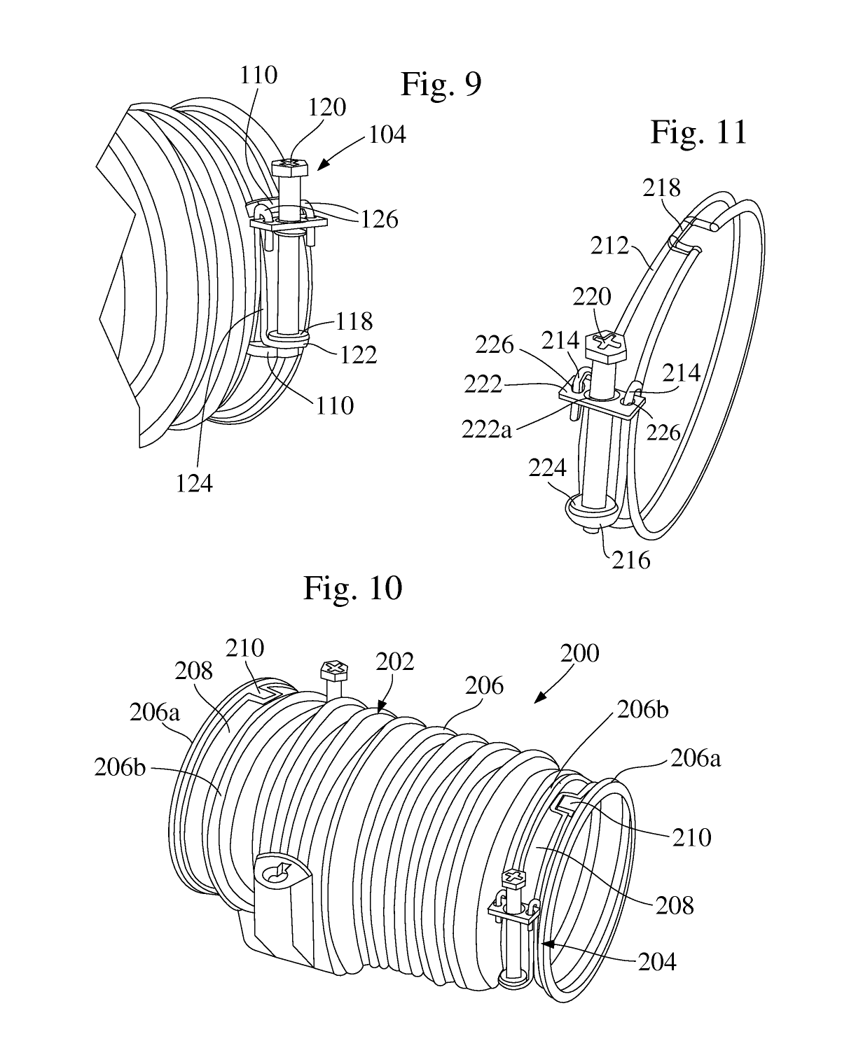

Referring to FIGS. 6-9, a clamp apparatus 100 is shown in accordance with another embodiment of the present disclosure. The clamp apparatus in this example includes a duct 102 and one or more wire clamps 104. The duct 102 is similar in construction to the duct 12 and includes a plurality of ribs 106 where a groove 108 may be formed at one or both ends thereof. In this example, however, the groove 108 includes a pair of radially projecting tabs 110, as best shown in FIG. 9, which are separated from one another by a predetermined angular spacing.

With reference to FIGS. 8 and 9, each tab 110 includes a pair of cutout sections 112 which allow portions of a spring 114 of the clamp 104 to extend there through. The clamp 104 in the clamp apparatus 100 is identical in construction to the clamp 14 of the clamp apparatus 10, and likewise includes a plate 116 with a threaded hole 116a, a threaded bolt 120 and a flange 118 fixedly secured to the threaded bolt 120. One of the tabs 110 serves to help keep the threaded bolt 120 in a predetermined angular orientation by acting as a “stop” which a U-shaped portion 122 of resilient spring material 124 abuts as pressure is applied to the threaded bolt 120 while tightening the clamp 104 on the duct 102. The other tab 110 helps to prevent movement of the clamp assembly 104 in the opposite angular direction by interfering with curved sections 126 of the resilient spring material 124. (Inventors: Does this sound correct? It would seem like we would only need one of the stops 110 and not two.) The tabs 110 in this example are of identical construction although they need not necessarily be identical.

Referring now to FIGS. 10 and 11, a clamp apparatus 200 is shown in accordance with another embodiment of the present disclosure. The apparatus 200 in this example includes a duct 202 and at least one clamp 204 at one end thereof. The duct 202 is similar to duct 12 and includes a plurality of ribs 206, with specific pairs of the ribs 206a and 206b defining a channel 208 at each end of the duct 202. Each of the channels 208 includes an indexing feature in the form of a raised section 210.

The clamp 204 is shown in greater detail in FIG. 11. The clamp 204 is somewhat similar in construction to the clamp 14 and includes a length of resilient spring material 212, for example spring steel (e.g., stainless steel) having curved end portions 214 at one end and a U-shaped portion 216 at its other end. In addition, the length of resilient spring material 212 includes a generally U-shaped intermediate feature 218 that is shaped generally in accordance with each of the raised sections 210. A threaded bolt 220 is engaged with a threaded opening 222a in a plate 222, and includes a fixedly attached flange 224. The curved portions 214 of the length of resilient spring material 212 engage within openings 226 in the plate 222 while the U-shaped portion 216 abuts the flange 224. The length of resilient spring material 212 is held in a predetermined angular orientation on the duct 202 by installing it such that the U-shaped intermediate feature 218 is positioned around the raised section 210. When installed in this manner the length of resilient spring material 212 of the clamp 204 is not able to rotate in the channel 208 as the threaded bolt 220 is tightened.

The various embodiments of the clamp apparatus described herein all form an effective, cost efficient and easy to implement means for enabling a clamp to be positioned and held on a duct in a desired angular orientation while the clamp is being tightened or loosened. The clamp apparatus requires only minimal modification to traditional ducts to implement. The clamp apparatus is considerably more cost efficient to employ than a standard band-style clamp because of the significantly reduced material costs associated with a wire-style clamp.

While various embodiments have been described, those skilled in the art will recognize modifications or variations which might be made without departing from the present disclosure. The examples illustrate the various embodiments and are not intended to limit the present disclosure. Therefore, the description and claims should be interpreted liberally with only such limitation as is necessary in view of the pertinent prior art.

What is claimed is:

1. A clamp apparatus comprising:
a duct having an indexing feature formed thereon;
a wire clamp having a length of resilient spring material shaped generally in accordance with a cross sectional configuration and diameter of the duct, and a tightening component operatively coupled to the length of resilient material;
a portion of the wire clamp engaging with the indexing feature to enable the wire clamp to be positioned and held in a desired angular orientation on the duct while being tightened on the duct using the tightening component.

2. The clamp apparatus of claim 1, wherein:
the duct comprises a channel formed at one end by a pair of ribs; and
wherein the indexing feature includes notched sections formed in the pair of ribs that form the channel, the notched sections forming surfaces against which a portion of the wire clamp abuts to limit rotational movement of the wire clamp as the wire clamp is tightened on the duct.

3. The clamp apparatus of claim 2, wherein:
the wire clamp includes a plate having a threaded hole;
the tightening component includes a threaded bolt that engages with the threaded hole, and
wherein the plate abuts the notched sections of the duct.

4. The clamp apparatus of claim 1, wherein:
the duct comprises a channel formed at one end by a pair of ribs; and
wherein the indexing feature includes:
a raised section in the channel; and
a U-shaped intermediate feature on the length of resilient spring material forming a portion of the wire clamp; and
wherein the U-shaped intermediate feature engages with the raised section to hold the wire clamp in a predetermined angular orientation and thus limit rotational movement of the wire clamp as the wire clamp is tightened on the duct.

5. The clamp apparatus of claim 1, wherein:
the duct comprises a channel formed at one end by a pair of ribs; and
wherein the indexing feature includes:
at least one radially extending tab projecting from the channel that abuts a portion of the wire clamp to prevent rotation of the wire clamp on the duct as the wire clamp is tightened.

6. The clamp apparatus of claim 5, wherein:
the tightening component comprises a threaded bolt having a flange at one end thereof that abuts a first portion of the length of resilient spring material; and
wherein the first portion of the length of resilient spring material abuts the at least one radially extending tab to help maintain the wire clamp in a predetermined angular orientation on the duct while the wire clamp is being tightened on the duct.

7. The clamp apparatus of claim 1, wherein the indexing feature comprises a pair of radially extending tabs projecting from the channel, and wherein one of the pair of radially extending tabs abuts a pair of curved end portions of the length of resilient spring material to help maintain the wire clamp in a predetermined angular orientation on the duct while the wire clamp is being tightened on the duct.

8. The clamp apparatus of claim 7, wherein each of the radially extending tabs includes a pair of cutout sections for receiving portions of the length of resilient spring material of the wire clamp.

9. The clamp apparatus of claim 1, wherein the wire clamp comprises a single length of resilient spring material.

10. A clamp apparatus comprising:
a duct having a pair of ribs at least at one end thereof that form a channel, the channel including an indexing feature formed in part by using the channel;
a wire clamp comprised of a length of resilient spring material shaped generally in accordance with a cross sectional configuration and diameter of the duct, and a threaded bolt operatively coupled to the length of resilient spring material, the wire clamp being further configured to reside at least substantially within the channel and to be maintained in the channel by the pair of ribs of the channel;
a portion of the wire clamp engaging with the indexing feature to enable the wire clamp to be positioned and held in a desired angular orientation on the duct while the threaded bolt is tightened.

11. The clamp apparatus of claim 10, wherein the indexing feature is formed by notched sections in the pair of ribs, the notched sections forming radially extending edge surfaces which engage with a portion of the wire clamp as the threaded bolt is being tightened.

12. The clamp apparatus of claim 11, wherein the portion of the wire clamp includes a U-shaped portion of the wire clamp at one end thereof, and where the U-shaped portion is supported against a plate, the plate being threadably engaged with the threaded bolt.

13. The clamp apparatus of claim 10, wherein the indexing feature is formed by at least one radially projecting tab that engages with a portion of the wire clamp.

14. The clamp apparatus of claim 13, wherein the radially projecting tab includes a pair of cutout sections for receiving portions of the length of resilient spring material of the wire clamp.

15. The clamp apparatus of claim 10, wherein the indexing feature comprises a pair of radially projecting tabs with a predetermined angular spacing that engage with a plurality of portions of the wire clamp to limit angular movement of the wire clamp as the wire clamp is tightened on the duct by threadably advancing the threaded bolt.

16. The clamp apparatus of claim 15, wherein each of the angular tabs includes a pair of cutout sections for receiving portions of the length of resilient spring material of the wire clamp.

17. The clamp apparatus of claim 10, wherein the indexing feature comprises a raised section of material in the channel, and wherein the length of resilient spring material comprises an U-shaped intermediate feature on the length of material forming the wire clamp which engages with the raised section of material in the channel to prevent rotation of the wire clamp in the channel as tightened on the duct.

18. The clamp apparatus of claim 10, wherein the wire clamp includes:
curved portions at a first end of the length of resilient spring material;
a plate having a threaded opening for engaging with the threaded bolt and a pair of openings for receiving the curved portions at the one end;
the bolt having a fixed flange at one end thereof; and
the length of material forming a U-shaped portion at a second end of the length of resilient spring material, the U-shaped portion engaging the fixed flange so that threadably advancing the threaded bolt into the plate causes a tightening of the wire clamp on the duct.

19. A method for forming a clamp apparatus, the method comprising:
providing a duct having a channel at least at one end, and forming the channel using a pair of ribs;
forming an indexing feature using the channel of the duct;
providing a wire clamp having a length of resilient spring material shaped generally in accordance with a cross sectional configuration and diameter of the duct, and a threaded bolt operatively coupled to the length of resilient spring material; and
using a portion of the wire clamp to engage with the indexing feature to enable the wire clamp to be positioned and held in a desired angular orientation on the duct while the threaded bolt is being tightened.

20. The method of claim 19, further comprising forming the indexing feature using at least of the following structural features:
a notched section in the ribs of the channel, which engages with a portion of the wire clamp to restrict rotation of the wire clamp;
a radially projecting tab in the channel which engages with a portion of the wire clamp to restrict rotation of the wire clamp; or
a raised material section in the channel that engages with a portion of the wire clamp to restrict rotation of the wire clamp.
